(19) United States
(12) Patent Application Publication
(10) Pub. No.: US 2026/0319153 A1
(43) Pub. Date: Oct. 15, 2026

(54) Reflective Polarizer and Optical Stack Including Reflective and Absorbing Polarizers

(71) Applicant: 3M INNOVATIVE PROPERTIES COMPANY, St. Paul, MN (US)

(72) Inventors: Adam D. Haag, Woodbury, MN (US); Kevin T. Huseby, Oakdale, MN (US); Samuel A. Minno, St. Paul, MN (US)

(21) Appl. No.: 19/491,490

(22) PCT Filed: Jun. 3, 2024
(86) PCT No.: PCT/IB2024/055416

§ 371 Date: Dec. 9, 2025

Related U.S. Application Data
(60) Provisional application No. 63/508,007, filed on Jun. 14, 2023.

(51) Int. Cl. G02B 5/30

(52) U.S. Cl. CPC G02B 5/305

(57) ABSTRACT

A reflective polarizer includes a plurality of polymeric layers numbering at least 10 in total where each of the polymeric layers has an average thickness of less than about 500 nm. An optical stack includes the reflective polarizer and an absorbing polarizer disposed on, and bonded to, the reflective polarizer. For a substantially normally incident light and for at least a first continuous wavelength range, the plurality of polymeric layers has an average reflectance of at least 50% when the incident light is polarized along a first in-plane direction and an average reflectance of at most 40% when the incident light is polarized along an orthogonal second in-plane direction. In some embodiments, a refractive index of each of at least some of the polymeric layers in the plurality of polymeric layers decreases along the second in-plane direction when the polymeric layer is stretched along the second in-plane direction.

### TECHNICAL FIELD

The present description relates generally to polarizers, and more specifically, to reflective polarizers and optical stacks including reflective and absorbing polarizers.

### BACKGROUND

A reflective polarizer can include a plurality of alternating polymeric layers that reflect a one polarization state while transmitting an orthogonal polarization state. An absorbing polarizer can include an iodine-stained polyvinyl alcohol (PVA) film.

### SUMMARY

In some aspects, the present description provides an optical stack including a reflective polarizer and an absorbing polarizer disposed on, and bonded to, the reflective polarizer. The reflective polarizer includes a plurality of polymeric layers numbering at least 10 in total where each of the polymeric layers has an average thickness of less than about 500 nm, such that for a substantially normally incident light, and for at least a first continuous wavelength range that is at least 5 nm wide and is disposed in an operating wavelength range extending from about 400 nm to about 800 nm: the plurality of polymeric layers has an average reflectance of at least 50% when the incident light is polarized along a first in-plane direction of the reflective polarizer and an average reflectance of at most 40% when the incident light is polarized along an orthogonal second in-plane direction of the reflective polarizer; and the absorbing polarizer has an average absorption of at least 30% when the incident light is polarized along a first in-plane direction of the absorbing polarizer and an average transmittance of at least 30% when the incident light is polarized along an orthogonal second in-plane direction of the absorbing polarizer. In some embodiments, a refractive index of each of at least some of the polymeric layers in the plurality of polymeric layers decreases along the second in-plane direction of the reflective polarizer when the polymeric layer is stretched along the second in-plane direction of the reflective polarizer. In some embodiments, each of some of the polymeric layers in the plurality of polymeric layers is negatively birefringent and each of some other of the polymeric layers in the plurality of polymeric layers is optically isotropic. In some embodiments, the plurality of polymeric layers has a first modulus along the first in-plane direction of the reflective polarizer and a second modulus along the second in-plane direction of the reflective polarizer, where the second modulus greater than the first modulus by at least 10%.

In some aspects, the present description provides a reflective polarizer including a plurality of alternating first and second polymeric layers numbering at least 10 in total where each layer of the plurality of alternating first and second polymeric layers has an average thickness of less than about 500 nm, such that for a substantially normally incident light, and for at least a first continuous wavelength range that is at least 5 nm wide and is disposed in an operating wavelength range extending from about 400 nm to about 800 nm: the plurality of alternating first and second polymeric layers has an average reflectance of at least 50% when the incident light is polarized along a first in-plane direction of the reflective polarizer and an average reflectance of at most 40% when the incident light is polarized along an orthogonal second in-plane direction of the reflective polarizer. For at least one wavelength in the operating wavelength range: the first and second polymeric layers have respective higher and lower average in-plane refractive indices where the first polymeric layers have a lower refractive index along the second in-plane direction than along the first in-plane direction; and the second polymeric layers can be substantially optically isotropic. In some embodiments, the first polymeric layers are negatively birefringent. In some embodiments, the plurality of alternating first and second polymeric layers has a first modulus along the first in-plane direction of the reflective polarizer and a second modulus along the second in-plane direction of the reflective polarizer, where the second modulus greater than the first modulus by at least 10%

These and other aspects will be apparent from the following detailed description. In no event, however, should this brief summary be construed to limit the claimable subject matter.

### BRIEF DESCRIPTION OF THE DRAWINGS

FIG. 1 is a schematic cross-sectional view of an optical stack, according to some embodiments.

FIG. 2 is a schematic illustration of stretching a plurality of polymeric layers to make a reflective polarizer, according to some embodiments.

FIG. 3 is a schematic cross-sectional view of an optical film undergoing a peel test, according to some embodiments.

FIGS. 4-9 are plots of reflectance versus wavelength for various reflective polarizers, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

As is known in the art, multilayer optical films including alternating polymeric layers can be used to provide desired reflection and transmission in desired wavelength ranges and desired polarization states by suitable selection of layer thicknesses and refractive index differences. Multilayer optical films and methods of making multilayer optical films are described in U.S. Pat. No. 5,882,774 (Jonza et al.); U.S. Pat. No. 6,783,349 (Neavin et al.); U.S. Pat. No. 6,949,212 (Merrill et al.); U.S. Pat. No. 6,967,778 (Wheatley et al.); U.S. Pat. No. 9,069,136 (Weber et al.); U.S. Pat. No. 9,162,406 (Neavin et al.); and U.S. Pat. No. 11,493,677 (Haag et al.), for example. The multilayer optical film can be a polymeric reflective polarizer.

Conventionally, polymeric reflective polarizers have been formed by extrusion along a machine direction (MD) followed by stretching along a transverse direction (TD) such that the resulting reflective polarizer has a block (reflection) axis along the transverse direction and a pass axis along the machine direction. However, absorbing polarizers have conventionally been formed by stretching a polymer layer (e.g., a polyvinyl alcohol layer) along a machine direction such that the resulting absorbing polarizer has a block axis along the machine direction and a pass axis along a transverse direction. In order to form an optical stack from such reflective and absorbing polarizers, sheets of the polarizers are typically cut out and bonded together after being rotated 90 degrees relative to each other in order to align the respective block and pass axes of the polarizers. However, it would be preferred if the step of cutting out sheets and rotating the polarizers relative to each other could be avoided. A reflective polarizer can be made by stretching in the machine direction so that the resulting block axis is along the machine direction, but this typically results in the film contracting along the transverse direction during stretching making it too narrow for large display sizes, for example.

According to some embodiments of the present description, a reflective polarizer is formed by extrusion along a machine direction followed by stretching along a transverse direction such that the resulting reflective polarizer has a block (reflection) axis along the machine direction and a pass axis along the transverse direction. The reflective polarizer can be bonded to an absorbing polarizer having a block axis along the machine direction (e.g., a conventional iodine-stained PVA-based absorbing polarizer). The reflective polarizer can include first and second polymeric layers where the first polymeric layers are negatively birefringent and have a refractive index that is reduced in the transverse direction upon stretching so that it approximately matches a lower refractive index of the second layers, resulting in an approximate index match in the transverse direction and a substantial index mismatch in the machine direction so that the block axis of the reflective polarizer is in the machine direction.

Negatively birefringent materials have previously been used in reflective polarizers to increase a refractive index difference between adjacent layers of the reflective polarizer in the transverse direction by using negatively birefringent lower index polymers and higher index isotropic or positively birefringent polymers, so that stretching along the transverse direction reduces the index of the lower index layers. Here, in contrast, negatively birefringent polymers are used, according to some embodiments, in higher index layers of a reflective polarizer to provide block and pass axes along respective machine and transverse directions.

Negative birefringence is a material property exhibited by some polymers that can result from symmetry of crystallites formed upon stretching of the polymer as described in U.S. Pat. No. 9,069,136 (Weber et al.), for example. Negatively birefringent polymer layers can have a lower refractive index along one in-plane direction (a direction in the plane along the layer or in a plane tangent to the layer) and approximately equal higher refractive indices along an orthogonal in-plane direction and along a thickness direction of the layer. Suitable polymers exhibiting negative birefringence include syndiotactic polystyrene (sPS), for example. Other suitable negatively birefringent polymers are described in U.S. Pat. No. 9,069,136 (Weber et al.). The optical film can include alternating negatively birefringent higher index and optically isotropic lower index layers. Suitable isotropic polymers include styrenic block copolymer, acrylic block copolymer, polymethylmethacrylate (PMMA), copolymers of PMMA, and blend thereof, for example. Other suitable isotropic polymers are described in the multilayer optical film references provided elsewhere herein.

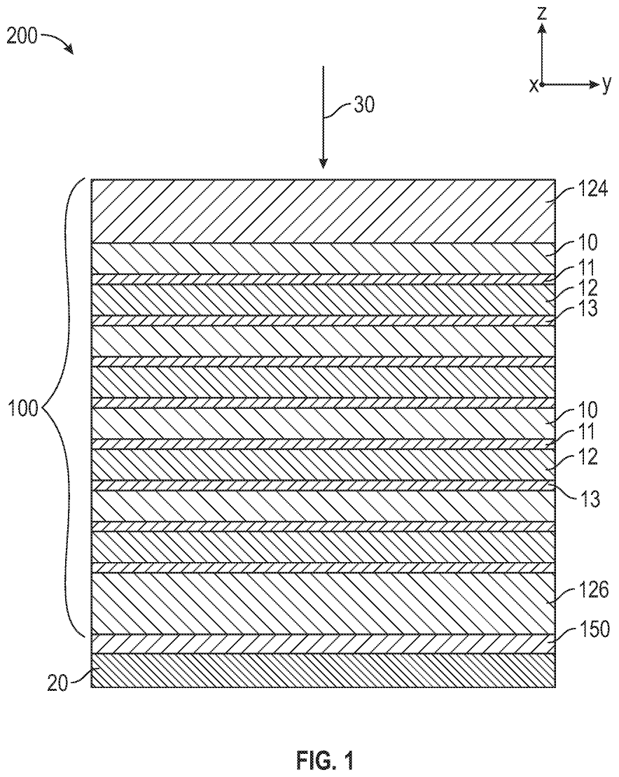

FIG. 1 is a schematic cross-sectional view of an optical stack 200, according to some embodiments. The optical stack 200 includes a reflective polarizer 100 and an absorbing polarizer 20 disposed on, and bonded to, the reflective polarizer 100. In some embodiments, an adhesive layer 150 bonds the absorbing polarizer 20 to the reflective polarizer 100.

The reflective polarizer 100 includes a plurality of polymeric layers 10, 11, 12, 13 numbering at least 10, or 25, or 50, or 100, or 200, or 300, or 400, or 500, or 600, or 700 in total. The total number of layers in the plurality of layers 10, 11, 12, 13 can be up to 5000, 2000, 1000, 800, or 700, for example. In some embodiments, the plurality of polymeric layers numbers at most 500, 450, 400, 350, 300, 250, 200, or 150 in total. The total number of layers of reflective polarizer 100 can depend, for example, on whether it is desired to have a wide reflection band (more layers) or a narrow reflection band (fewer layers), or a plurality of substantially non-overlapping narrow reflection bands, for example. In some embodiments, the layers 11 and 13 are omitted and a total number of the plurality of polymeric layers 10 and 12 is in any of these ranges. In some embodiments, each of the polymeric layers 10, 11, 12, 13 has an average thickness of less than about 500, or 400, or 300, or 200 nm, for example. The average thicknesses can be at least about 10, 20, 30, 40, 50, or 60 nm, for example. In some embodiments, the plurality of polymeric layers 10, 11, 12, 13 include a plurality of alternating first and second polymeric layers 10 and 12. In some embodiments, optional layers 11 and 13 are included for improved interlayer bonding, for example. In other embodiments, layers 11 and 13 are omitted. In some embodiments, for each second polymeric layer 12 of at least a majority (or at least 60, 70, 80, 90, or 95 percent) of the second polymeric layers 12, each of opposing major surfaces of the second polymeric layer directly contacts a major surface of an adjacent first polymeric layer 10.

In some embodiments, the plurality of layers 10, 11, 12, 13 are disposed between first and second skin layers 124 and 126. In some embodiments, each of the first and second skin layers 124 and 126 has an average thickness of greater than about 400, 500, 600, 700, 800, 900, 1000, 1250, 1500, 1750, or 2000 nm. The average thickness of each of the skin layers can be up to about 150, 100, 50, 30, 20, or 10 microns, for example. As would be appreciated by those of ordinary skill in the art, the reflective polarizer 100 may optionally include other layers (e.g., protective boundary layers) that may each have an average thickness in any of the ranges described for the skin layers 124, 126.

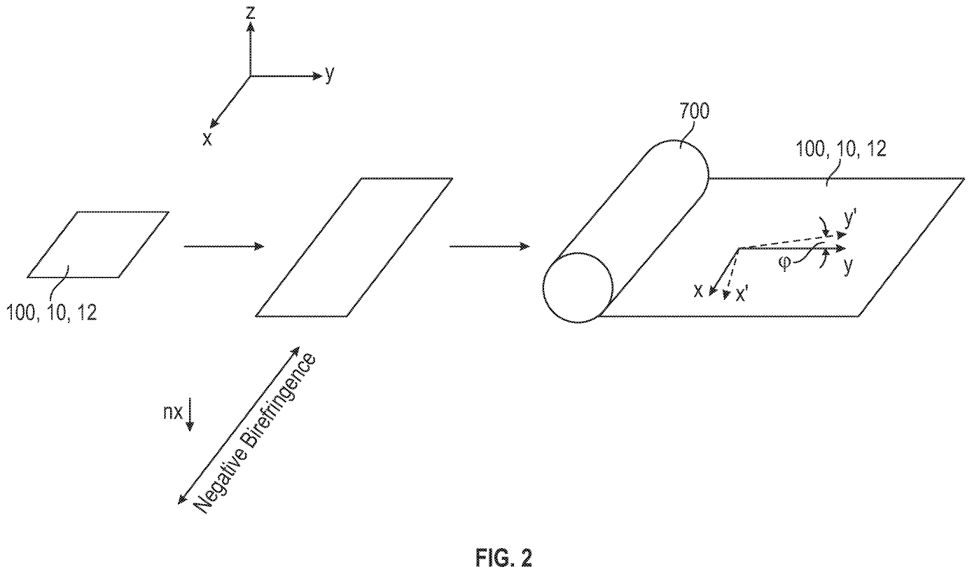

FIG. 2 is a schematic illustration of stretching a plurality of polymeric layers to make a reflective polarizer 100, according to some embodiments. In some embodiments, the polymeric layers (e.g., 10, 12) of the reflective polarizer 100 are coextruded along a first in-plane direction (y-direction, machine direction, block axis) of the reflective polarizer and co-stretched along an orthogonal second in-plane direction (x-direction, transverse direction, pass axis) of the reflective polarizer. Traditionally, reflective polarizers are formed by stretching along the block axis of the reflective polarizer. However, it has been found, according to some embodiments, that it is advantageous to form a reflective polarizer by stretching along the pass axis of the reflective polarizer. It has been found that compared to conventional reflective polarizers, such reflective polarizers can be more readily oriented with an absorbing polarizer such that the block axes of the reflective and absorbing polarizers are aligned, as described further elsewhere herein. In some embodiments, the reflective polarizer 100 is rolled into a roll 700. In some embodiments, the reflective polarizer 100 and the absorbing polarizer 20 are bonded together via adhesive layer 150 in a roll-to-roll process. In some embodiments, a roll 700 of optical film is provided, where the optical film is or includes the reflective polarizer with the first in-plane direction being along a circumference of the roll and the second in-plane direction being along a width of the roll. In some embodiments, the optical film in the roll 700 includes the absorbing polarizer 20 (e.g., the optical film in the roll 700 can correspond to optical stack 200). The optical film in the roll 700 can be at least 5, 10, 20, 30, 40, or 50 m long, for example, in a direction along the circumference of the roll.

In some embodiments, the absorbing polarizer 20 has a first in-plane direction (y′-direction) along a block axis of the absorbing polarizer and an orthogonal second in-plane direction (x′-direction) along a pass axis of the absorbing polarizer. In some embodiments, the first in-plane directions (y-and y′-directions) of the reflective and absorbing polarizers are substantially parallel (e.g., parallel to within 15 degrees). In some embodiments, the first in-plane directions of the reflective and absorbing polarizers define an angle φ therebetween of less than about 12, 10, 8, 6, 5, 4, 3, 2, or 1 degrees. The angle φ may be zero degrees or nominally zero degrees, for example.

In some embodiments, forming a reflective polarizer by stretching along the pass axis of the reflective polarizer is achieved by utilizing negatively birefringent polymer for higher refractive index layers and substantially isotropic polymer for lower refractive index layers. A negatively birefringent polymer can be characterized by a refractive index of the polymer decreasing along a stretch direction when the polymer is stretched along the stretch direction. In some embodiments, a refractive index of each of at least some of the polymeric layers (e.g., layers 10) in the plurality of polymeric layers decreases along the second in-plane direction (x-direction) of the reflective polarizer when the polymeric layer is stretched along the second in-plane direction (x-direction) of the reflective polarizer. In other words, in some embodiments, the at least some of the polymeric layers in the plurality of polymeric layers have the material property of negative birefringence. The refractive index here can be for at least one wavelength (e.g., 532 nm, 550 nm, and/or 633 nm) in an operating wavelength range extending from about 400 nm to about 800 nm. In some embodiments, for at least one wavelength in the operating wavelength range, each of the at least some of the polymeric layers in the plurality of polymeric layers has indices of refraction ny and nx in the respective first and second in-plane directions of the reflective polarizer, where ny is greater than nx by at least about 0.05, 0.06, 0.07, 0.08, 0.09, or 0.1.

In some embodiments, the reflective polarizer includes a plurality of alternating first and second polymeric layers 10 and 12. In some embodiments, the at least some of the polymeric layers include the first, but not the second, polymeric layers. In some embodiments, for at least one wavelength in an operating wavelength range extending from about 400 nm to about 800 nm: the first and second polymeric layers 10 and 12 have respective higher and lower average in-plane refractive indices where the first polymeric layers 10 can be negatively birefringent and/or can have a lower refractive index along the second in-plane direction (x-direction) than along the first in-plane direction (y-direction); and the second polymeric layers can be substantially optically isotropic (e.g., a maximum difference between indices in two different direction can be no more than about 0.04). In some embodiments, each of the first polymeric layers 10 has indices of refraction ny1, nx1, and nz1 in the respective first and second in-plane directions and an orthogonal thickness direction (z-direction) of the reflective polarizer, and each of the second polymeric layers has indices of refraction ny2, nx2, and nz2 in the respective first and second in-plane directions and the thickness direction of the reflective polarizer. In some embodiments, for the at least one wavelength in the operating wavelength range: a maximum difference between ny2, nx2, and nz2 (i.e., the largest one of |ny2−nx2|, |ny2−nz2|, and |nx2—nz2|) is less than 0.04; |nyl−nz1|<0.04; ny1−nx1>0.05; |nx1−nx2|<0.06; and ny1−ny2>|nx1−nx2|+0.04. In some embodiments, the maximum difference between ny2, nx2, and nz2 is less than 0.035, 0.03, 0.025, 0.02, 0.015, or 0.01. In some embodiments, |ny1−nz1|<0.035, 0.03, 0.025, 0.02, 0.015, or 0.01.

In some embodiments, ny1−nx1>0.06, 0.07, 0.08, 0.09, or 0.1. In some embodiments, |nx1−nx2|<0.055, 0.05, 0.045. 0.04, 0.035, 0.03, 0.025, or 0.02. In some embodiments, ny1−ny2−>|nx1−nx2|+0.05, 0.06, 0.07, 0.08, 0.09, or 0.1. In some embodiments, ny1−nx1>|ny2−nx2|+0.02, 0.03, 0.04, 0.05, 0.06, 0.07, 0.08, 0.09, or 0.1.

In some embodiments, each of the first polymeric layers 10 comprises syndiotactic polystyrene and each of the second polymeric layers 12 comprises styrenic block copolymer. In some embodiments, the styrenic block copolymer comprises styrene-ethylene-butylene-styrene (SEBS) block copolymer. Suitable styrenic block copolymers include those available from KRATON corporation (Houston, TX) such as KRATON G1645 and KRATON G1657, for example. Suitable sPS includes those available from Idemitsu Kosan Co., Ltd. (Tokyo, Japan) such as XAREC 142ZE, for example.

In some embodiments, the reflective polarizer has a high delamination resistance. For example, it has been found that alternating layers of sPS and styrenic block copolymer (e.g., SEBS) can result in a high delamination resistance. In some embodiments, the reflective polarizer 100, 100′ includes a plurality of polymeric layers (e.g., 10-13, 124, 126) including the plurality of plurality of alternating first and second polymeric layers 10, 12. The plurality of polymeric layers may further include at least one layer 124, 126 having an average thickness of greater than about 600 nm (or in a range described elsewhere herein). In some embodiments, when the reflective polarizer is scored by cutting through at least some of the plurality of polymeric layers to result in a plurality of scored polymeric layers, then the scored reflective polarizer has a delamination resistance along at least one peel direction (e.g., along a block and/or a pass direction of the reflective polarizer) of no less than about 200, 300, 400, 500, 600, 700, 800, 900, 1000 g/in under a 90 degree, 10 in/min peel test.

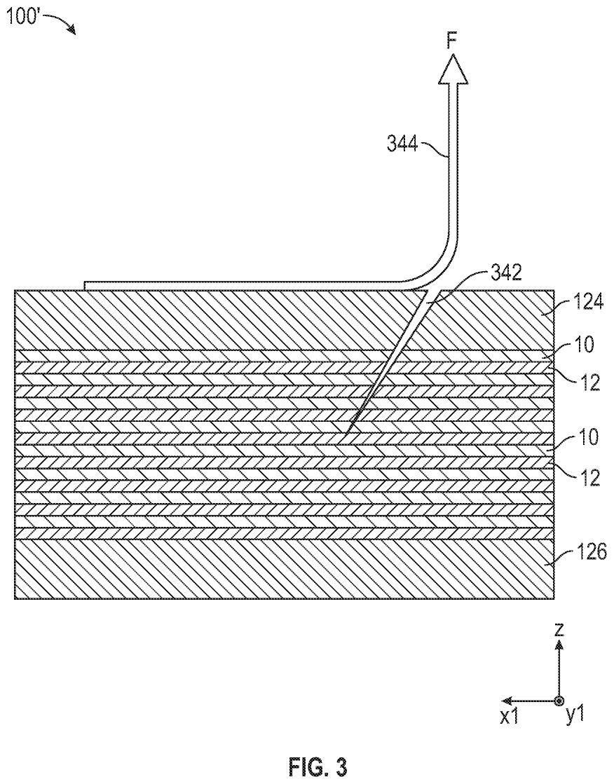

FIG. 3 is a schematic cross-sectional view of a reflective polarizer 100′ undergoing a peel test, according to some embodiments. The reflective polarizer 100′ can correspond to reflective polarizer 100, for example. A 90 degree peel test with peel force F is schematically illustrated. The peel force F may be described as a delamination along the x1-direction (referring to the illustrated x1-y1-z coordinate system) since the separated layers peel along the x1-direction. The x1-direction may correspond to either the x-direction or the y-direction of FIGS. 1-2, for example. The 90 degree peel test can be carried out at a peel speed of 10 inches per min, for example. In some embodiments, the delamination resistance is the average resistance-to-peel strength determined according to the ASTM D6862-11 (Reapproved 2016) test standard. In some embodiments, the reflective polarizer is scored (a score 342 that can be formed by cutting with a razor blade, for example, is schematically illustrated) by cutting through at least some of the plurality of polymeric layers 10, 12 (or at least some of the layers 10, 11, 12, 13 if the reflective polarizer includes layers 11 and 13) to result in a plurality of scored polymeric layers, and a tape 344 is attached to a major surface of the optical film and pulled in the peel test. In some embodiments, the plurality of scored polymeric layers includes at least some of the plurality of alternating first and second polymeric layers 10 and 12. In some embodiments, at least some of the plurality of polymeric layers of the scored optical film are not scored. In some embodiments. it can be determined in a peel test that the delamination resistance is greater than a specified limit (e.g., when no delamination is observed when a peel is attempted at the specified limit), but it can be difficult to determine a precise value of the delamination resistance due the difficulty in getting the layers to delaminate at all when the delamination resistance is high.

The plurality of polymeric layers (or the plurality of alternating first and second polymeric layers, or the reflective polarizer) of the reflective polarizer 100 may be characterized by modulus. In contrast to conventional reflective polarizers, the polymeric layers may have a higher modulus along the pass direction than along the block direction. It has been found, according to some embodiments, that this can result from using negatively birefringent polymer for the higher refractive index layers. In some embodiments, the plurality of polymeric layers (or the plurality of alternating first and second polymeric layers, or the reflective polarizer) has a first modulus Ey along the first in-plane direction (y-direction) of the reflective polarizer 100 and a second modulus Ex along the second in-plane direction (x-direction) of the reflective polarizer 100, where the second modulus Ex is greater than the first modulus Ey by at least 10, 20, 40, 60, 80, 100, 120, 140, 160, 180, 200, 220, or 240%. A modulus along a direction should be understood to be the tensile Young's modulus along that direction, unless indicated differently. The modulus can be measured according to the ASTM D638-14 test standard, for example.

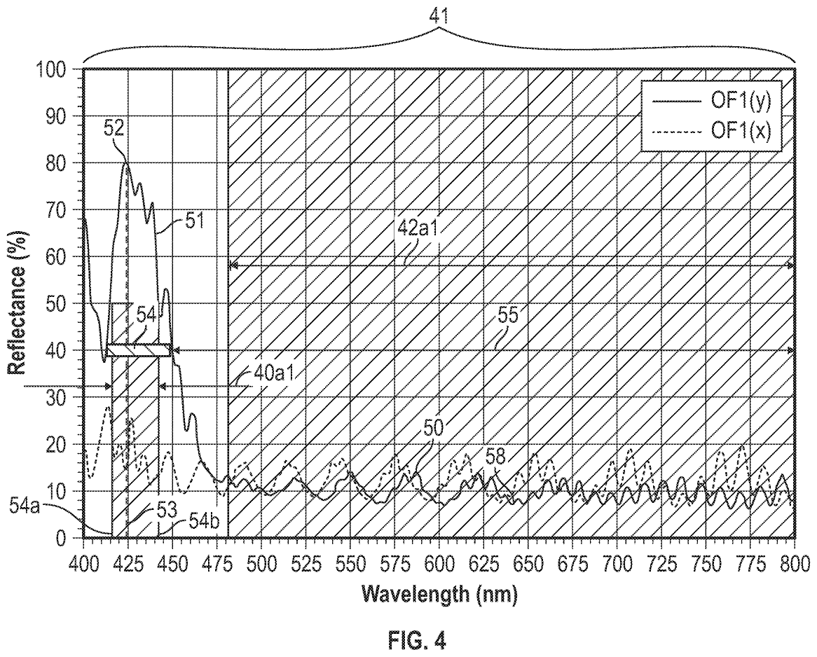

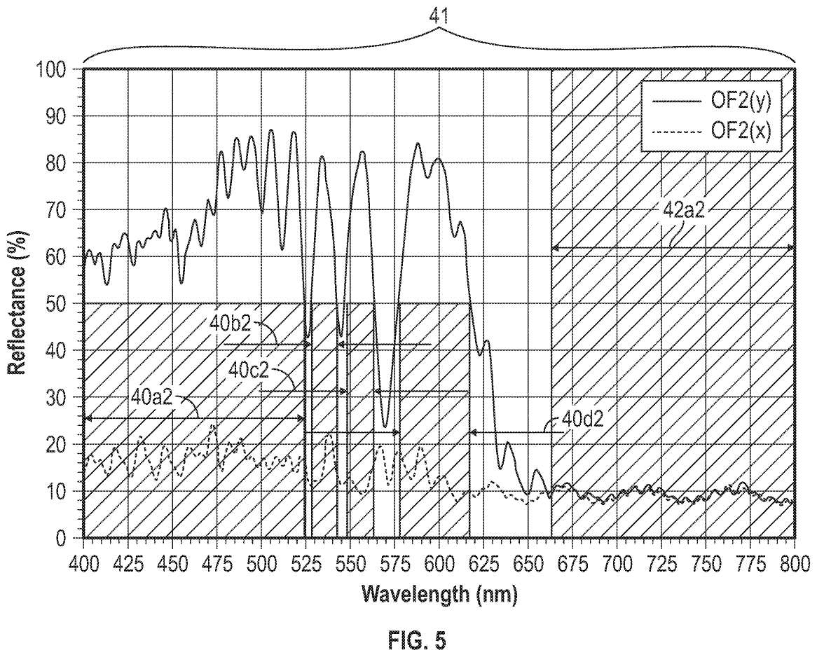

FIGS. 4-9 are plots of normal incidence reflectance versus wavelength for various reflective polarizers, according to some embodiments. The reflective polarizers are labeled OF1-OF6 and the (x) or (y) indicate the polarization axis of the incident light. The reflective polarizer of FIG. 4 (OF1) was made as follows. The reflective polarizer included alternating first and second layers 10 and 12 formed from respective first and second polymers. The first polymer was syndiotactic polystyrene (sPS) available from Idemitsu Kosan Co., Ltd. (Tokyo, Japan) under the tradename XAREC 142ZE. The second polymer was styrene-ethylene-butylene-styrene (SEBS) block copolymer available from KRATON Corporation (Houston, TX) under the tradename KRATON G1645. The ratio of the feed rate of the first polymer to the second polymer was 10:13. The materials were fed from separate extruders to a multilayer coextrusion feedblock, in which they were assembled into a packet of 212 optical repeat units each including first and second layers, plus a thicker protective boundary layer formed of the second polymer on each side, for a total of 426 layers. The multilayer melt was then cast through a film die onto a chill roll, in the conventional manner for polyester films, upon which it was quenched. The cast web was then stretched in a commercial scale linear tenter at a draw ratio approximately 6:1 and a temperature of 275 deg. F. The reflective polarizer of FIG. 5 (OF2) was made similarly but the thicknesses of the alternating first and second layers were adjusted to produce the spectra of FIG. 5. The modulus along the MD (block) and TD (pass) directions for the reflective polarizer OF1 was 168 ksi and 445 ksi, respectively. The delamination resistance of OF1 was too high to measure precisely but was determined to be not less than 1000 g/in along each of the MD (block) and TD (pass) directions.

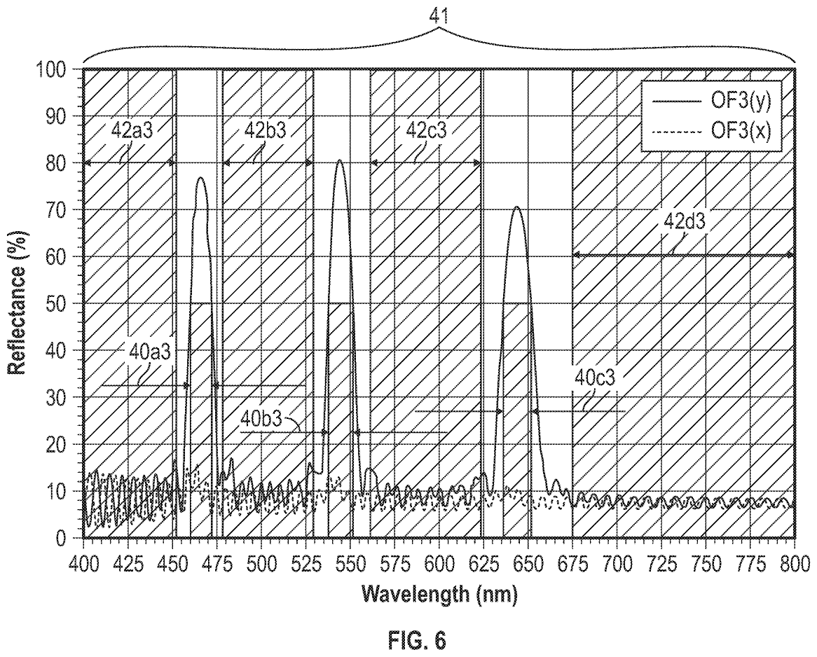

The reflective polarizers of FIGS. 6-9 were determined using standard optical modeling techniques for alternating layers of sPS and SEBS with layer thickness profiles chosen to produce the illustrated spectra. The refractive indices of the sPS layers were modeled as 1.512, 1.620, and 1.620 along x-, y-, and z-directions at 633 nm and the refractive indices of the SEBS layers were modeled as 1.493 along each direction at 633 nm. It will be understood that the reflective polarizers of FIGS. 4-9 are provided for illustrative purposes and that the reflective polarizers of the present description may utilize other polymers and layer thickness profiles.

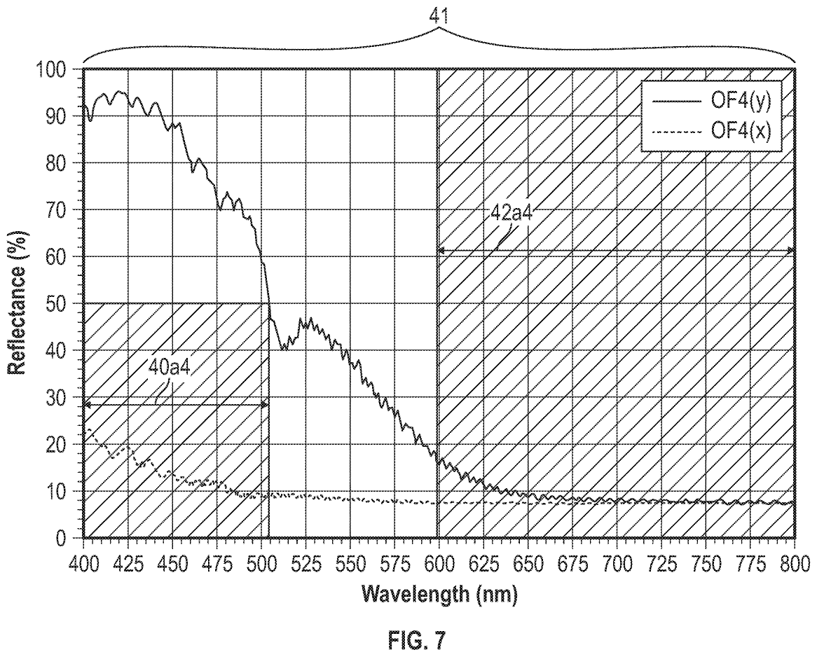

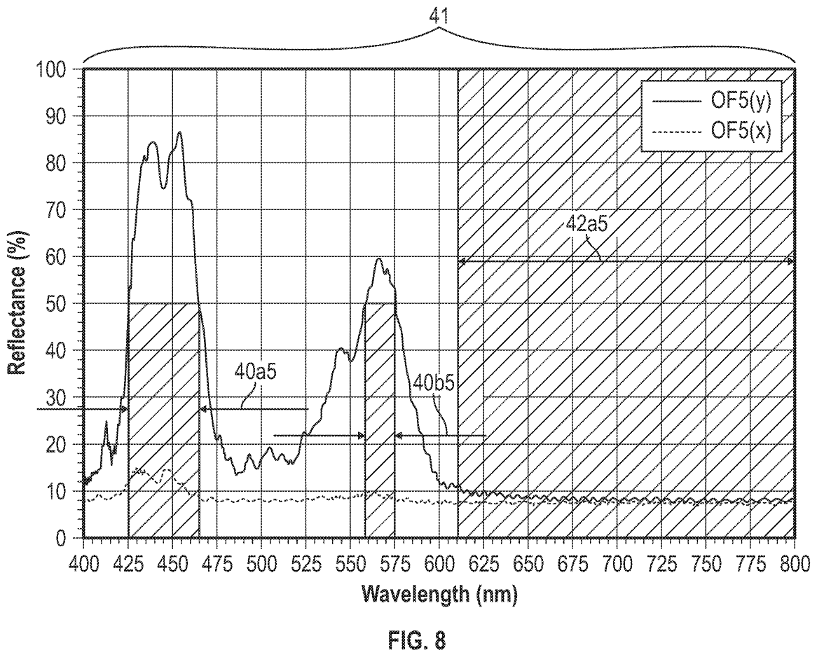

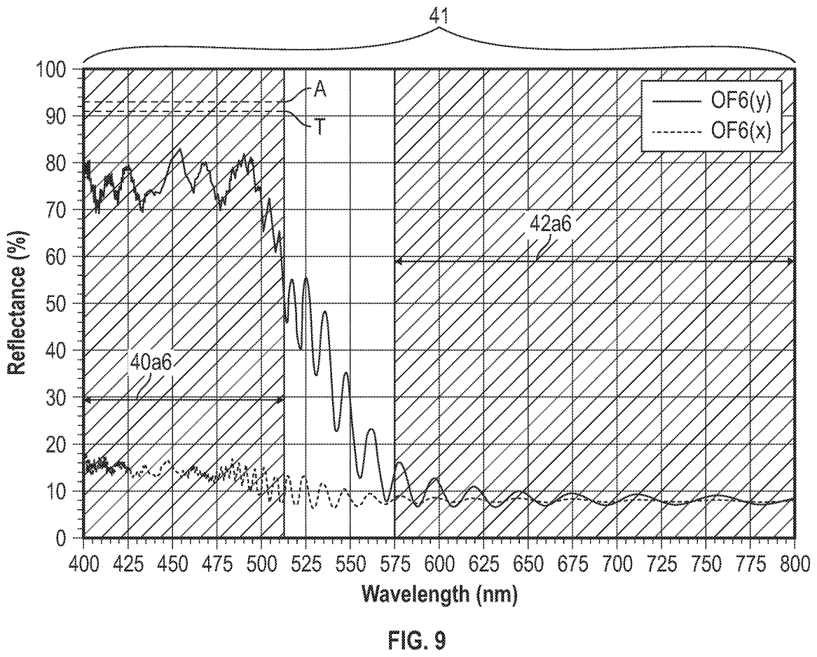

In some embodiments, for a substantially normally incident (e.g., within 30 degrees of normally incident) light 30 (see, e.g., FIG. 1), and for at least a first continuous wavelength range (e.g., 40a1 depicted in FIG. 4; 40a2, 40b2, 40c2, 40d2 depicted in FIG. 5; 40a3, 40b3, 40c3 depicted in FIG. 6; 40a4 depicted in FIG. 7; 40a5, 40b5 depicted in FIG. 8; or 40a6 depicted in FIG. 9) that is at least 5 nm wide and is disposed in an operating wavelength range 41 extending from about 400 nm to about 800 nm, the plurality of polymeric layers 10, 11, 12, 13 (or the plurality of alternating first and second polymeric layers 10 and 12, or the reflective polarizer 100) has an average reflectance of at least 50% when the incident light is polarized along a first in-plane direction of the reflective polarizer and an average reflectance of at most 40% when the incident light is polarized along an orthogonal second in-plane direction of the reflective polarizer. In some embodiments, for the substantially normally incident light 30, and for the at least a first continuous wavelength range, the absorbing polarizer 20 has an average absorption (e.g., average absorption A depicted in FIG. 9) of at least 30% when the incident light is polarized along a first in-plane direction (y-direction or y′-direction depicted in FIG. 2) of the absorbing polarizer and an average transmittance (e.g., average transmittance T depicted in FIG. 9) of at least 30% when the incident light is polarized along an orthogonal second in-plane direction (x-direction or x′-direction depicted in FIG. 2) of the absorbing polarizer. The substantially normally incident light 30 can be within 25, 20, 15, or 10 degrees of normal incidence, for example.

In some embodiments, the first continuous wavelength range is at least 10, 15, 20, 30, 40, 50, 75, or 100 nm wide. The at least a first continuous wavelength range can include a plurality of mutually non-overlapping continuous wavelength ranges (see, e.g., FIGS. 5, 6 and 8) where each continuous wavelength range can have a width as described for the first continuous wavelength range and is disposed in the operating wavelength range. The average reflectance, average transmittance and/or average absorption of the reflective and/or absorbing polarizers in each of the plurality of continuous wavelength ranges can be in any of the ranges described for the first continuous wavelength range.

In some embodiments, for a second continuous wavelength range (e.g., 42a1 depicted in FIG. 4; 42a2 depicted in FIG. 5; 42a3, 42b3, 42c3, 42d3 depicted in FIG. 6; 42a4 depicted in FIG. 7; 42a5 depicted in FIG. 7; or 42a6 depicted in FIG. 9) that is at least 30 nm wide and is disposed in the operating wavelength range, the plurality of polymeric layers 10, 11, 12, 13 (or the plurality of alternating first and second polymeric layers 10 and 12, or the reflective polarizer 100) has an average reflectance of at most 40% for each of first and second polarization states along the respective the first and second in-plane directions of the reflective polarizer. In some embodiments, the average reflectance is at most 35, 30, 25, 20, 15, or 10% for each of the first and second in-plane directions of the reflective polarizer. In some embodiments, the second wavelength range is at least 40, 50, 60, 70, 80, 90, 100, 150, 200 nm wide.

In some embodiments, the plurality of polymeric layers has an average reflectance of at least 55, 60, 65, 70, or 75% when the incident light is polarized along the first in-plane direction of the reflective polarizer. In some embodiments, the plurality of polymeric layers has an average reflectance of at most 35, 30, 25, 20, or 15% when the incident light is polarized along the second in-plane direction of the reflective polarizer. The reflective polarizer can be substantially non-optically absorbing so that for each polarization state, the average transmittance is about 100 percent minus the average reflectance.

In some embodiments, the absorbing polarizer has an average absorption of at least 40, 50, 60, 70, 80, or 90% when the incident light is polarized along a first in-plane direction of the absorbing polarizer. In some embodiments, the absorbing polarizer has an average transmittance of at least 40, 50, 60, 70, 80, or 90% when the incident light is polarized along the second in-plane direction of the absorbing polarizer. Suitable absorbing polarizers include those available from Sanritz Corporation (Tokyo, Japan), for example.

In some embodiments, as can be seen in FIG. 4, for example, for the substantially normally incident light 30: for the incident light polarized along the first in-plane direction (y-direction, block) of the reflective polarizer 100, a plot 50 of an optical reflectance of the plurality of polymeric layers as a function of a wavelength in the operating wavelength range comprises a first reflection band 51 having a first reflection peak 52 at a first wavelength 53 and a corresponding first full width at half maximum (FWHM) 54 extending from a lower first wavelength 54a to a higher first wavelength 54b, where the first reflection peak 52 is greater than about 50%; and for the incident light polarized along the second in-plane direction (x-direction, pass) of the reflective polarizer 100, the plurality of polymeric layers has a global reflection minimum 58 of greater than about 2% and less than about 20% in a wavelength range 55 extending from the higher first wavelength 54b to about 700 nm. The global minimum of a quantity in a specified wavelength range is the smallest value of the quantity in that range. In some embodiments, the first reflection peak 52 is greater than about 55, 60, 65, 70, or 75%. In some embodiments, the global reflection minimum is greater than about 3, 4, 5, 6, or 7%. In some embodiments, the global reflection minimum is less than about 18, 16, 14, 12, or 10%.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1-15. (canceled)

16. An optical stack comprising:
a reflective polarizer comprising a plurality of polymeric layers numbering at least 10 in total, each of the polymeric layers having an average thickness of less than about 500 nm; and
an absorbing polarizer disposed on, and bonded to, the reflective polarizer,
such that for a substantially normally incident light, and for at least a first continuous wavelength range that is at least 5 nm wide and is disposed in an operating wavelength range extending from about 400 nm to about 800 nm:
the plurality of polymeric layers has an average reflectance of at least 50% when the incident light is polarized along a first in-plane direction of the reflective polarizer and an average reflectance of at most 40% when the incident light is polarized along an orthogonal second in-plane direction of the reflective polarizer; and
the absorbing polarizer has an average absorption of at least 30% when the incident light is polarized along a first in-plane direction of the absorbing polarizer and an average transmittance of at least 30% when the incident light is polarized along an orthogonal second in-plane direction of the absorbing polarizer,
wherein the plurality of polymeric layers comprises a plurality of alternating first and second polymeric layers;
wherein a refractive index of each of the first polymeric layers decreases along the second in-plane direction of the reflective polarizer when the first polymeric layer is stretched along the second in-plane direction of the reflective polarizer; and
wherein each of the first polymeric layers has indices of refraction ny1, nx1, and nz1 in the respective first and second in-plane directions and an orthogonal thickness direction of the reflective polarizer, and each of the second polymeric layers has indices of refraction ny2, nx2, and nz2 in the respective first and second in-plane directions and the thickness direction of the reflective polarizer, such that for at least one wavelength in the operating wavelength range:
the first and second polymeric layers have respective higher and lower average in-plane refractive indices;
a maximum difference between ny2, nx2, and nz2 is less than 0.04;

|ny1−nz1|<0.04;
ny1−nx1>0.05;

|nx1−nx2|<0.06; and
ny1−ny2>|nx1−nx2|+0.04.

17. The optical stack of claim 16, wherein the plurality of polymeric layers numbers at most 500 in total.

18. The optical stack of claim 16, wherein an adhesive layer bonds the absorbing polarizer to the reflective polarizer.

19. The optical stack of claim 16, wherein each of the first polymeric layers comprises syndiotactic polystyrene, and each of the second polymeric layers comprises styrenic block copolymer, and wherein for each second layer in at least 90% of the second layers, each of opposing major surfaces of the second polymeric layer directly contacts a major surface of an adjacent first layer.

20. The optical stack of claim 19, wherein the styrenic block copolymer comprises styrene-ethylene-butylene-styrene block copolymer.

21. The optical stack of claim 16, wherein for the substantially normally incident light and for a second continuous wavelength range that is at least 30 nm wide and is disposed in the operating wavelength range, the plurality of polymeric layers has an average reflectance of at most 40% for each of first and second polarization states along the respective first and second in-plane directions of the reflective polarizer.

22. The optical stack of claim 16, wherein for the substantially normally incident light:
for the incident light polarized along the first in-plane direction of the reflective polarizer, a plot of an optical reflectance of the plurality of polymeric layers as a function of a wavelength in the operating wavelength range comprises a first reflection band having a first reflection peak at a first wavelength and a corresponding first full width at half maximum (FWHM) extending from a lower first wavelength to a higher first wavelength, wherein the first reflection peak is greater than about 50%; and
for the incident light polarized along the second in-plane direction of the reflective polarizer, the plurality of polymeric layers has a global reflection minimum of greater than about 2% and less than about 20% in a wavelength range extending from the higher first wavelength to about 700 nm.

23. A reflective polarizer comprising:
a plurality of alternating first and second polymeric layers numbering at least 10 in total, each layer of the plurality of alternating first and second polymeric layers having an average thickness of less than about 500 nm,
such that for a substantially normally incident light, and for at least a first continuous wavelength range that is at least 5 nm wide and is disposed in an operating wavelength range extending from about 400 nm to about 800 nm:
the plurality of alternating first and second polymeric layers has an average reflectance of at least 50% when the incident light is polarized along a first in-plane direction of the reflective polarizer and an average reflectance of at most 40% when the incident light is polarized along an orthogonal second in-plane direction of the reflective polarizer,
wherein each of the first polymeric layers has indices of refraction ny1, nx1, and nz1 in the respective first and second in-plane directions and an orthogonal thickness direction of the reflective polarizer, and each of the second polymeric layers has indices of refraction ny2, nx2, and nz2 in the respective first and second in-plane directions and the thickness direction of the reflective polarizer, such that for at least one wavelength in the operating wavelength range:
the first and second polymeric layers have respective higher and lower average in-plane refractive indices, the first polymeric layers being negatively birefringent;
a maximum difference between ny2, nx2, and nz2 is less than 0.04;

|ny1−nz1|<0.04;
ny1−nx1>0.05;

|nx1−nx2|<0.06; and
ny1−ny2>|nx1−nx2|+0.04.

24. The reflective polarizer of claim 23, wherein the reflective polarizer comprises a plurality of polymeric layers comprising the plurality of alternating first and second polymeric layers, and when the reflective polarizer is scored by cutting through at least some of the plurality of polymeric layers to result in a plurality of scored polymeric layers, then the scored reflective polarizer has a delamination resistance along at least one peel direction of no less than about 200 g/in under a 90 degree, 10 in/min peel test.

25. The reflective polarizer of claim 23, wherein each of the first polymeric layers comprises syndiotactic polystyrene, and each of the second polymeric layers comprises styrene-ethylene-butylene-styrene block copolymer, and wherein for each second layer in at least 90% of the second layers, each of opposing major surfaces of the second polymeric layer directly contacts a major surface of an adjacent first layer.

26. The reflective polarizer of claim 25, wherein the styrenic block copolymer comprises styrene-ethylene-butylene-styrene block copolymer.

27. An optical stack comprising:
a reflective polarizer comprising a plurality of polymeric layers numbering at least 10 in total,
each of the polymeric layers having an average thickness of less than about 500 nm; and
an absorbing polarizer disposed on, and bonded to, the reflective polarizer,
such that for a substantially normally incident light, and for at least a first continuous wavelength range that is at least 5 nm wide and is disposed in an operating wavelength range extending from about 400 nm to about 800 nm:
the plurality of polymeric layers has an average reflectance of at least 50% when the incident light is polarized along a first in-plane direction of the reflective polarizer and an average reflectance of at most 40% when the incident light is polarized along an orthogonal second in-plane direction of the reflective polarizer; and
the absorbing polarizer has an average absorption of at least 30% when the incident light is polarized along a first in-plane direction of the absorbing polarizer and an average transmittance of at least 30% when the incident light is polarized along an orthogonal second in-plane direction of the absorbing polarizer,
wherein the plurality of polymeric layers has a first modulus along the first in-plane direction of the reflective polarizer and a second modulus along the second in-plane direction of the reflective polarizer, the second modulus greater than the first modulus by at least 10%;
wherein each of the first polymeric layers has indices of refraction ny1, nx1, and nz1 in the respective first and second in-plane directions and an orthogonal thickness direction of the reflective polarizer, and each of the second polymeric layers has indices of refraction ny2, nx2, and nz2 in the respective first and second in-plane directions and the thickness direction of the reflective polarizer; and
wherein the plurality of polymeric layers comprises a plurality of alternating first and second polymeric layers, such that for at least one wavelength in the operating wavelength range:
the first and second polymeric layers have respective higher and lower average in-plane refractive indices;
a maximum difference between ny2, nx2, and nz2 is less than 0.04;

|ny1−nz1|<0.04;
ny1−nx1>0.05;

|nx1−nx2|<0.06; and
ny1−ny2>|nx1−nx2|+0.04.

28. The optical stack of claim 27, wherein each of the first polymeric layers comprises syndiotactic polystyrene, and each of the second polymeric layers comprises styrenic block copolymer, and wherein for each second layer in at least 90% of the second layers, each of opposing major surfaces of the second polymeric layer directly contacts a major surface of an adjacent first layer.

29. The optical stack of claim 28, wherein the styrenic block copolymer comprises styrene-ethylene-butylene-styrene block copolymer.
